(19) United States
(12) Patent Application Publication
(10) Pub. No.: US 2003/0014608 A1
(43) Pub. Date: Jan. 16, 2003

(54) Method of providing stack memory in an operating system with stack memory constraints

(76) Inventor: Ronald G. Mercer, Mississauga (CA)

Correspondence Address: FINNEGAN, HENDERSON, FARABOW, GARRETT &, DUNNER LLP, 1300 I STREET, NW, WASHINGTON, DC, 20006, US

(21) Appl. No.: 09/903,592

(22) Filed: Jul. 13, 2001

(51) Int. Cl. G06F 12/00

(52) U.S. Cl. 711/170

(57) ABSTRACT

The present invention is directed at a method of providing stack memory in an operating system with stack memory constraints. During operation, software modules executing on the operating system may require more than the allotted stack memory, therefore, in order to avoid stack overflow, more stack memory is required. Therefore, in accordance with a preferred embodiment of the present invention, upon initial execution of the software module, a request is sent to the operating system for the provision of more stack memory. The operating system then returns an address location within the operating system's memory where more stack memory may be provided. A new stack pointer value corresponding to the new address location is stored in the stack pointer value register and the existing stack pointer value is then stored in a pre-determined register. After the software module has finished executing, the existing stack pointer value stored in the predetermined register is retrieved and replaces the stack pointer value in the stack pointer value register.

### FIELD OF THE INVENTION

The present invention relates in general to stack memory, and, more specifically, to a method of providing stack memory in an operating system with stack memory constraints.

### BACKGROUND OF THE INVENTION

Memory mapping is generally used in operating systems where memory is required to perform a specific function and the existing allotted memory is not enough. In these cases, the operating system assigns extra memory to assist in the execution of the function. Although this is used for general memory, the same cannot be said for stack memory. When dealing with stack memory, especially on an operating system that runs on constrained devices, a software module usually does not have its own separate stack or has very limited memory size for stack usage. When the software module doesn't have its own stack it is forced to use the stack of the upper layer that invokes it. If the software module's stack requirements are larger than the stack that it has been given, a stack overflow will occur and the operating system will usually crash or become unstable.

Therefore it is an object of the present invention to provide a method of providing stack memory to a software module executing on an operating system with stack memory constraints in which the above disadvantages are obviated or mitigated.

### SUMMARY OF THE INVENTION

The present invention is directed at a method of providing stack memory in an operating system with stack memory constraints.

In general, software modules within the operating system may require more stack memory than the software module may be allotted and therefore the chance to failure due to insufficient stack memory increases. Therefore, the present invention provides a method of reducing the chance of errors occurring due to insufficient stack memory by providing a novel method of providing stack memory in an operating system with stack memory constraints.

In accordance with an aspect of the present invention, there is provided a method for providing stack memory to a software module stored in an operating system with stack memory constraints comprising:

sensing initiation of said software module;

allocating a pre-determined amount of stack memory to said software module;

storing an existing stack pointer value in a predetermined location; and

receiving a stack pointer value from said operating system associated with said pre-determined amount of stack memory.

In accordance with another embodiment, there is provided a method of method of providing stack memory to a software module executing in an operating system with stack memory constraints comprising the steps of:

sending a request for extra stack memory to said operating system;

receiving a predetermined address location corresponding to said request;

storing an existing stack pointer value located in a stack pointer value register to a predetermined location;

replacing said existing stack pointer value in said stack pointer value register with an operating system stack pointer value corresponding to said predetermined address location.

During operation, software modules executing on the operating system may require more than the allotted stack memory, therefore, in order to avoid stack overflow, more stack memory is required. Therefore, in accordance with a preferred embodiment of the present invention, upon initial execution of the software module, a request is sent to the operating system for the provision of more stack memory. The operating system then returns an address location within the operating system's memory where more stack memory may be provided. A new stack pointer value corresponding to the new address location is stored in the stack pointer value register and the existing stack pointer value is then stored in a pre-determined register. After the software module has finished executing, the existing stack pointer value stored in the predetermined register is retrieved and replaces the stack pointer value in the stack pointer value register.

### BRIEF DESCRIPTION OF THE DETAILED DRAWINGS

An embodiment of the present invention will now be described by way of example only with reference to the accompanying drawings in which:

FIG. 1 is a schematic drawing of a computing device; and

FIG. 2 is a flowchart outlining a method of allocating memory for stack usage.

### DETAILED DESCRIPTION OF THE PREFERRED EMBODIMENT

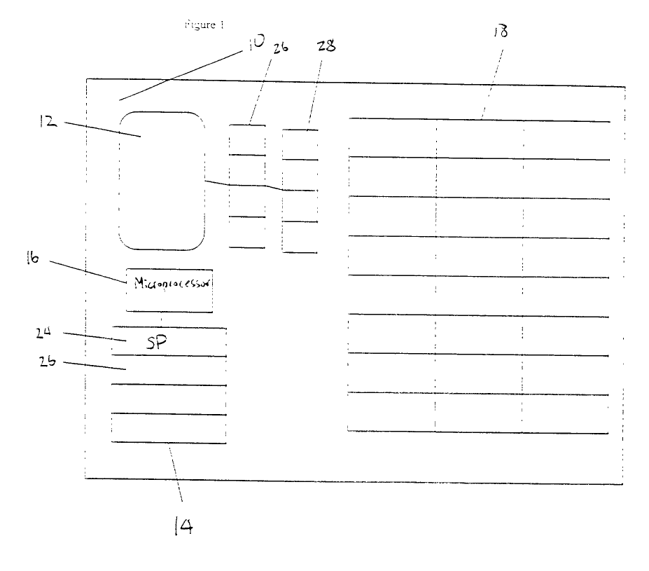

Turning to FIG. 1, a schematic diagram of a computing device 10 is shown. It will be understood that the FIG. 1 includes those aspects which assist in the implementation of the present invention. Other hardware aspects of the computing device 10 are not shown. The computing device 10 includes a software module 12, a register table 14, a microprocessor 16 and a large amount of unused stack memory 18. The software module 12 is connected to software module stack memory 20 which is less than the large amount of unused stack memory 18. The microprocessor 16 is connected to the register table 14. The register table 14 includes a stack pointer value register 22 as well as a temporary stack pointer value storage register 24.

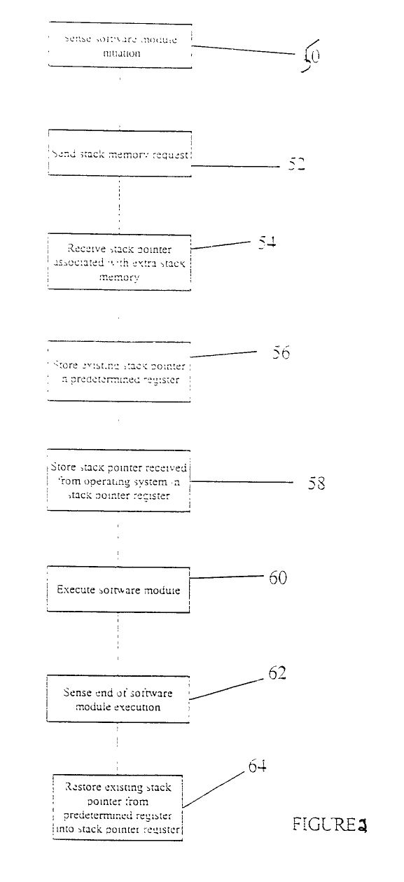

Turning to FIG. 2, a flowchart outlining a method of allocating memory for stack usage is shown. Initially, when the software module 12 begins to execute (step 50), two separate stack memories 26 and 28 for transmitting and receiving information packets are formed. It will be understood by one skilled in the art that communication between the software module 12 and the microprocessor 16 occurs using information packets.

In many cases, the amount of memory reserved for the two stack memories 26 and 28 is quite small. Therefore, if a larger amount of stack memory is required for transmitting and receiving information packets, as requested by a software module handler, to avoid an error due to insufficient stack memory, extra stack memory is required from the computing device 10. The microprocessor 16 of the computing device 10 generally controls the location of all memory, including the large amount of unused stack memory 18. In order to receive more stack memory, a message is sent by the software module 12 to the microprocessor 16 requesting a larger amount of stack memory (step 52). The microprocessor 16 then returns a stack pointer value corresponding to address location wherein the large amount of unused stack memory 18 is available for use by the software module 14 (step 54). After receiving the stack pointer value, the software module 12 moves the existing stack pointer value stored in the stack pointer value register 22 to a temporary stack pointer value storage register 24 for storage (step 56). The stack pointer value provided by the microprocessor 16 is then stored in the stack pointer value register 22 (step 58). The software module 12 then executes (step 60). When execution of the software module 12 is finished, the software modules 12 notifies the microprocessor 16 and releases the stack pointer value stored in the stack pointer value register 22 (step 62). The existing stack pointer value is then retrieved from the temporary stack pointer value storage register 24 and stored in the stack pointer value register 22 (step 64) and operation of the microprocessor returns to its original state i.e. the large amount of stack memory 18 is reset. The large amount of stack memory 18 is only released when the software module 12 has finished executing.

It will be understood that the existing stack pointer value does not affect overall operation of the software module 12.

It will also be understood that the software module 12 is generally a driver which is located between layers and which requires stack memory for its operation and storage of information packets.

Also, the software module 12 may not require a handler to request more stack memory, the request may be sent upon initiation of the software module 12.

This solution can also be used for critical places in any software/firmware when the size of the stack provided by the OS is not sufficient and must be increased for normal software module (driver) operation.

It will further be understood that the amount of stack memory allocated by the microprocessor is dependent on the amount of stack memory available in the large amount of stack memory and no other factors.

It will further be understood that some of the steps may be performed in an alternate manner that described. For instance, the extra stack memory may not be allocated until the stack pointer values have been sent.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for providing stack memory to a software module stored in an operating system with stack memory constraints comprising:
sensing initiation of said software module;
allocating a pre-determined amount of stack memory to said software module;
storing an existing stack pointer value in a predetermined location; and
receiving a stack pointer value from said operating system associated with said pre-determined amount of stack memory.

2. The method of claim 1 further comprising the step of storing said stack pointer value in a stack pointer value register.

3. The method of claim 2 further comprising the step of de-allocating said predetermined amount of stack memory by retrieving said existing stack pointer value and storing said existing stack pointer value in said stack pointer value register.

4. The method of claim 1 wherein said software module is a driver.

5. The method of claim 1 wherein said predetermined location is a register or said stack memory.

6. The method of claim 2 further comprising the step of executing said software module requiring said pre-determined amount of stack memory.

7. A method of method of providing stack memory to a software module executing in an operating system with stack memory constraints comprising the steps of:
sending a request for extra stack memory to said operating system;
receiving a predetermined address location corresponding to said request;
storing an existing stack pointer value located in a stack pointer value register to a predetermined location;
replacing said existing stack pointer value in said stack pointer value register with an operating system stack pointer value corresponding to said predetermined address location.

8. The method of claim 7 further comprising the step of
replacing said operating system stack pointer value with said existing stack pointer value after said software module has executed.

9. The method of claim 8 wherein a step of retrieving said existing stack pointer value from said predetermined location occurs before said step of replacing said operating system stack pointer value.

10. The method of claim 7 wherein a step of initiating execution of said software module occurs before said step of sending a request for more stack memory.

11. The method of claim 10 wherein said step of initiating execution is a packet processing request or a software module start up.

12. The method of claim 8 further comprising the step of executing said software module occurring before said step of replacing said operating system stack pointer value.
